(19) United States
(12) Patent Application Publication
(10) Pub. No.: US 2010/0068566 A1
(43) Pub. Date: Mar. 18, 2010

(54) METHOD FOR MINIMIZING MEMBRANE ELECTRODE DEGRADATION IN A FUEL CELL POWER PLANT

(76) Inventors: Sathya Motupally, Milford, CT (US); Carl A. Reiser, Stonington, CT (US)

Correspondence Address: Stephen A. Schneeberger, 49 Arlington Road, West Hartford, CT, 06107, US

(21) Appl. No.: 12/448,124

(22) PCT Filed: Dec. 21, 2006
(86) PCT No.: PCT/US2006/049025

§ 371 Date: Jun. 9, 2009

(51) Int. Cl. H01M 8/00; H01M 4/00

(52) U.S. Cl. 429/13; 429/40

(57) ABSTRACT

A method and apparatus for mitigating decay of multiple membrane electrode assemblies (20) in a fuel cell stack (12). Each membrane electrode assembly (20) includes an anode (16) and a cathode (18) on respectively opposite sides of a proton exchange membrane (14). The positioning of a plane of potential change (Xₒ) is controlled to be/maintained outside the membrane and within the cathode of each membrane electrode assembly, both during regular electrical load cycling and during relatively idle operation of a primary electrical load (28) connected to the fuel cell stack. A determination (22, 24, 54, 50) of electrical demand on the fuel cell stack is reflective of either regular electrical load cycling or relatively idle operation, and during relatively idle operation a secondary electrical load (52) is connected (26, 24″) to the stack and/or a flow of air (36) to the cathode is regulated (62, 60) to maintain the plane of potential change (Xₒ) outside the membrane.

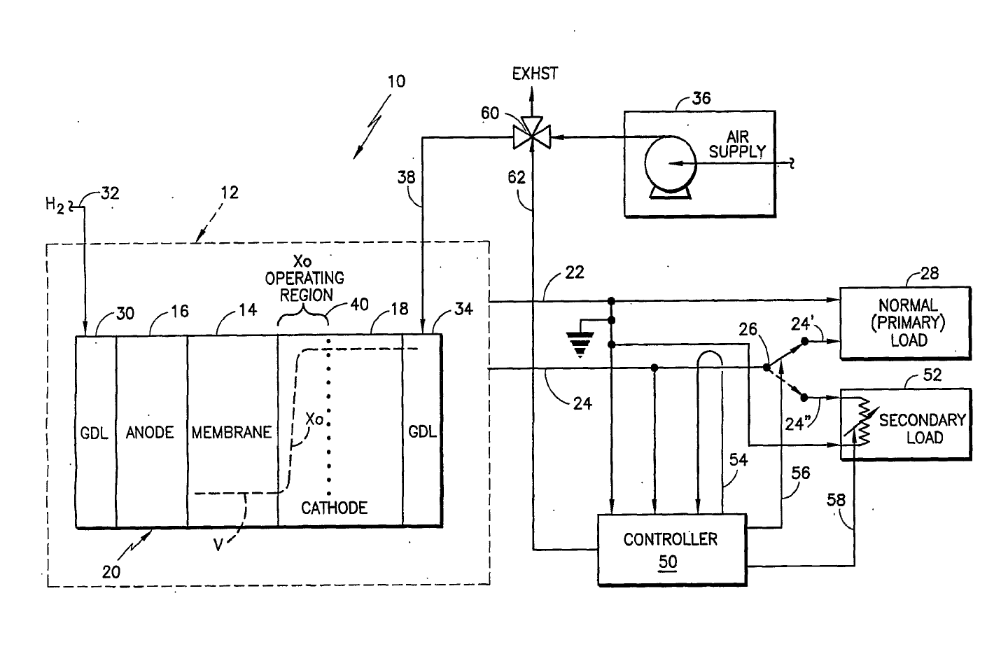

### TECHNICAL FIELD

This invention relates to fuel cell power plants, and more particularly to power plants having PEM fuel cells. Still more particularly, the invention relates to the avoidance or minimization of degradation of the membrane of such fuel cells.

### BACKGROUND OF THE DISCLOSURE

The polymer electrolyte/proton exchange membranes (PEM) in fuel cell stacks of fuel cell power plants are subject to degradation as the result of peroxide formation and/or existence in the vicinity of the membrane. This peroxide can dissociate into highly reactive free radicals, which can in turn degrade the membrane. This interferes with the desire to achieve 40,000-70,000 hour and 5,000-10,000 hour lifetimes for stationary and transportation PEM fuel cells, respectively.

The aforementioned process of membrane degradation by peroxide formation is described in U.S. Pat. No. 7,112,386 by Cipollini, et al and assigned to the assignee of the present invention. Its solution provides one or more peroxide decomposition catalyst regions positioned in or near one or more of the anode, the cathode, and the membrane.

More recently, a further technique for addressing this general problem has been disclosed in a pending PCT application published on Sep. 8, 2005 as 20050196661 and assigned to the assignee of the present invention, in which there is recognition that there is a plane of sharp change in electrical potential (hereinafter “plane of potential change”) between the electrodes during operation of the membrane electrode assembly (MEA). This plane of potential change is conveniently designated “Xₒ”, and represents where the reaction potential abruptly shifts from a low value to a high value. The location of Xₒ depends largely on the oxidant and fuel gas concentrations at locations on either side of that plane of potential change.

Significantly, it had been found that electrically isolated, dissolved catalyst particles, typically Pt, tend to precipitate at Xₒ, thereby increasing the chance of formation of peroxide and/or radicals which can have a deleterious effect upon the membrane.

During electrical load cycling of the MEA, the concentration of reactants varies and the position of Xₒ can move. When this happens, there is increased tendency toward dissolution of catalyst metal from the previous Xo location to the new Xₒ location, which may be especially damaging to the membrane.

In an effort to prevent or mitigate this problem, a protective “underlayer” of ionomer material containing a particulate catalyst has been provided between the membrane and the cathode. The protective underlayer serves to scavenge oxygen and hydrogen during normal operation and thus forces Xₒ to reside within the protective layer. During off-load, or relatively idle, operating conditions, an air-starvation protocol serves to keep Xₒ within the protective underlayer.

Although the use of the protective underlayer is viewed as effective in mitigating the problems described, it nevertheless represents the inclusion of an additional structure in the MEA. More specifically, the use of the protective underlayer both adds to the cost of the MEA as well as having some adverse impact on the performance of the MEA by causing an increase in ionic resistance between the electrodes.

It is therefore a primary object of the present disclosure to provide a membrane electrode assembly in a fuel cell power plant which avoids or minimizes certain shortcomings associated with the Xₒ plane without reliance upon a protective underlayer.

It is a further object of the disclosure to provide a method for operating a fuel cell which further addresses these issues.

These and other objects and advantages will be apparent herein.

### DISCLOSURE OF INVENTION

In accordance with the present invention, the foregoing objects and advantages have been attained. Most catalyst, e.g. Pt, dissolution takes place during excursions to high voltage that occur during idle or off-load conditions. The catalyst typically deposits at the Xₒ plane, and it is important to keep Xₒ out of the membrane during these conditions. This is accomplished by voltage clipping, air starvation, or a combination of both, without requiring a protective underlayer.

According to the invention, a fuel cell power plant comprises a fuel cell stack including a plurality of membrane electrode assemblies, each having a cathode with a catalyst and a reactant air flow field and an anode with a reactant fuel flow field on opposite sides of a proton exchange membrane, the cathode catalyst having an interface with the membrane; an air supply connected to the air flow fields for providing reactant air to the cathodes; a fuel supply connected to the fuel flow fields for providing reactant fuel to the anodes; and a primary electrical load selectively powered by said fuel cell stack; and the invention is characterized by a plane of potential change normally occurring outside the proton exchange membrane at or near the cathode catalyst/membrane interface during operation of the fuel cell stack for electrical load cycling of the primary electrical load, but inside the proton exchange membrane during periods of relatively idle operation; at least one of: an interrupter operatively connected with the air supply and the cathode air flow fields for selectively interrupting the supply of air to the flow fields and a secondary electrical load for selective connection with the fuel cell stack during periods of relatively idle operation; and a controller responsive to electrical demand of the primary electrical load to control at least one of the air supply interrupter to interrupt some of the supply of air to the cathode air fields and the secondary electrical load for connection to the fuel cell stack during periods of relatively idle operation, thereby to maintain the plane of potential change outside the proton exchange membrane also during periods of relatively idle operation.

In one embodiment of the invention, both the air supply interrupter and the secondary electrical load are present, and the controller acts to control both to maintain the plane of potential change outside the proton exchange membrane also during periods of relatively idle operation. The extent to which each of the air supply interrupter and the secondary electrical load are controlled may be a function of their respective efficiency penalties in the fuel cell power plant.

In further accordance with the invention, a method is provided for mitigating decay of a membrane electrode assembly in a fuel cell, which method comprises selectively operating a membrane electrode assembly in an electrical load cycle and in relatively idle operation, the membrane electrode assembly having a cathode with a catalyst and a reactant air flow field and an anode with a reactant fuel flow field on opposite sides of a proton exchange membrane, the cathode catalyst having an interface with the membrane, and operating the membrane electrode assembly differently between an electrical load cycle and a period of relatively idle operation for maintaining a plane of potential change between the anode and the cathode to be outside the proton exchange membrane and in the cathode throughout operation in both an electrical load cycle and a period of relatively idle operation. The method is conveniently effected by controlling one, or both, of the electrical loading on the fuel cell and the supply of air to the cathode, as a function of electrical demand on the fuel cell. The extent to which each of the electrical loading on the fuel cell and the supply of air to the cathode is controlled may be a function of their respective efficiency penalties.

The monitored electrical demand to effect control action may be any combination of power or current or output voltage from the fuel cell to the primary electrical load, with an individual cell voltage of about 0.85 to 0.9 volts serving as one prominent threshold parameter.

The foregoing features and advantages of the present invention will become more apparent in light of the following detailed description of exemplary embodiments thereof as illustrated in the accompanying drawings.

### BRIEF DESCRIPTION OF DRAWING

The FIGURE is a schematic illustration of a fuel cell power plant having a fuel cell membrane electrode assembly and associated load and controls, functionally illustrating the arrangement for maintaining the Xₒ plane outside the membrane under load/no load conditions in accordance with the invention.

### BEST MODE FOR CARRYING OUT THE INVENTION

Referring to the Figure, there is shown in simplified schematic illustration a fuel cell power plant 10 including a fuel cell stack 12 comprising a plurality of contiguous membrane electrode assemblies (MEA), each having a proton exchange (or polymer electrolyte) membrane (PEM) 14 between an anode 16 and a cathode 18 on opposite sides thereof, only one membrane electrode assembly 20 being shown in the Figure. The electrical output at the positive and negative terminals of the fuel cell stack 12 is connected by a pair of lines 22, 24 through a switch 26 to a normal, or primary, electrical load 28. The normal load 28 may be an electric motor associated with an electric propulsion system for a vehicle or it may be any of a variety of other known electrical loads that are operated/powered by the fuel cell stack 12 during normal operation.

Referring to the membrane electrode assembly 20 in greater detail, the anode 16 includes a gas diffusion layer 30 for the introduction of hydrogen (H₂) from a source (not shown in detail) via line 32 to the anode 16. Similarly, a gas diffusion layer 34 associated with the cathode 18 serves to admit oxidant reactant, such as air from air supply blower 36, to the cathode 18 via line 38. As is well known, the membrane electrode assembly 20 is operated by feeding oxygen through the gas diffusion layer 34 to cathode 18 and by feeding H₂ through gas diffusion layer 30 to anode 16. These reactants support generation of an ionic current across the membrane 14 as desired. The fuel cell power plant 10 and membrane electrode assembly 20 may also include a water circulation system/water transport plates (not separately shown here). Similarly, other aspects of a conventional fuel cell power plant not essential to an understanding of the invention are omitted from the Figure and description for the sake of brevity, but their presence is assumed.

Both the anode 16 and the cathode 18 are porous layers containing suitable respective catalysts. Typically the respective catalysts are at the surfaces of the anode and cathode that are in contact with the membrane electrode assembly 20. In fact, those catalysts may even be adhered to the surfaces of the membrane electrode assembly 20, but in each event form a respective interface between the membrane and the respective cathode catalyst or anode catalyst. During operation of the membrane electrode assembly 20, catalyst materials which are typically present in the anode and cathode electrodes can dissolve and then precipitate elsewhere in the assembly.

The Figure depicts a broken line V in the membrane electrode assembly 20 which is illustrative of the relative electrical potential at that location in the assembly. It will be noted that there is a plane Xₒ of sharp potential change between the electrodes, where the potential abruptly shifts from a low value to a high value. The position of Xₒ depends heavily on the oxidant and reductant gas concentrations at locations on either side off Xₒ. Moreover, it has been found that dissolved catalyst tends to precipitate at Xₒ and further, that the electrically isolated catalyst particles can increase the formation of peroxide and/or radicals. Because of the potentially degrading characteristics of such activity on the membrane 14 if it occurs within the membrane, it is important to avoid such activity at that location.

In accordance with the invention, the power plant 10 is configured and operated such that the fuel cell stack 12, and thus the membrane electrode assembly 20, are operated in a manner to assure that the Xₒ plane of abrupt potential change is in, and remains in, an Xₒ operating region 40 that is outside the membrane 14 and within the cathode 18, whether in normal on-load operating conditions (i. e. electrical load cycling) or in off-load (i. e., relatively idle) conditions. While such positioning of the Xₒ plane may not entirely prevent some of the adverse activity attendant to its presence, such as peroxide formation, it nevertheless removes it from the more-sensitive membrane 14 to the relatively less-sensitive cathode 18.

During normal cyclic operation of the power plant 10, in which the fuel cell stack 12 is connected via lines 22, 24 and switch 26 to the normal, or primary, load 28, the electrical load on the stack 12 is sufficient, though perhaps varying, to assure that the consumption of H₂ and oxygen occurs at a rate that places their interface, and thus the Xₒ plane, clearly outside the membrane 14 and within the Xₒ operating region 40. During such operation, the electrical potential between the electrodes, and thus lines 22 and 24, is less than 0.9 V, typically being in the range of 0.55 to 0.85 volts. On the other hand, during no-load, or relatively idle, operation when the normal load 28 is not in the circuit, the potential across the electrodes and between lines 22 and 24 may increase to greater than 0.9V, giving rise to an undesired shifting of the Xₒ plane toward or into the membrane 14. To prevent this, additional means/measures are provided to assure that the Xₒ plane remains outside the membrane 14.

Referring further to the Figure, the power plant 10 additionally includes at least one, and typically two, controlled arrangements for maintaining the Xₒ plane outside the membrane 14 and within the desired Xₒ operating region 40 within the cathode 18. Specifically, either one or both, of the electrical loading on the fuel cell stack 12 and the supply of air to the cathode 18, are controlled as a function of the electrical demand on the fuel cell stack 10. That electrical demand may be monitored and/or determined typically as a measure of voltage, current and/or power, though cell stack temperature may also be relied upon as an indirect indicator.

One end terminal of the fuel cell stack 12 provides the reference voltage that appears on the line 22, and is additionally extended to a controller 50 and also to a secondary, or auxiliary, load 52. The secondary load 52 has for purposes of simplicity of illustration been shown in the Figure as a variable resistance, but it will be understood that it might alternatively or additionally be a battery, a capacitor and/or some other energy storage device. The type of device selected as secondary load 52 may be determined by the degree to which it does/does not impose an efficiency penalty on the fuel cell power plant. For example, an energy storage device such as a capacitor might be favored relative to a pure power-dissipating resistance. The other end terminal of the fuel cell stack 12 provides the potential difference that is developed across the fuel cell stack under a respective connected load, and appears on line 24. Line 24 provides an input to the controller 50, and as noted previously, is connected to a terminal of switch 26. Switch 26 is functionally illustrated as being of the single-pole, double-throw type, and is operable to connect line 24 to either line 24′ connected to the primary load 28 or to line 24″ connected to the secondary load 52.

A current detector 54 connected to the controller 50 and operatively associated with line 24 or 22 provides a measure of the current to the controller. The voltage across lines 22 and 24 is also provided as an input to the controller 50. Additional measures of the electrical loading of the fuel cell stack 12 by the electrical load, as for instance stack temperature, may also be supplied to controller 50. The controller 50 uses one or more of these inputs to measure electrical demand by the connected load on the fuel cell stack to thereby determine transitions between a normal cyclical load regime and an idle or no-load regime. This is perhaps most conveniently achieved by monitoring the potential between lines 22 and 24, since it is preferable to keep such potential below about 0.85 volts in the no-load condition to maintain the Xₒ plane within the desired Xₒ operating region 40.

While the potential between lines 22 and 24 is normally less than 0.9 volts, typically being in the range of 0.55 volts to 0.85 volts when the fuel cell stack 12 is connected to a load 28 operating under cyclical conditions, that voltage may increase to 0.9 volts or more if the primary load is significantly reduced, as at idle. Accordingly, a control line 56 connected from controller 50 to switch 26 serves to toggle that switch such that a/the secondary load 52 is connected between lines 22 and 24. The secondary load 52 may replace the primary load 28 across the lines 22 and 24, as by the illustrated switching arrangement, or it may simply be connected in parallel with that primary load 28 during such time as that primary load is operating to impose little or no load on the stack. Either way, the inclusion of the secondary load 52 may serve to assure that the potential between lines 22 and 24 is maintained below about 0.9 V, i.e., “clipped”. It will be appreciated that the impedance/resistance of the secondary load 52 may be controllably varied by control line 58 from controller 50 if such is deemed desirable as part of the control scheme.

Either alternatively or additionally, the location of the Xₒ plane may also be maintained within the desired Xₒ operating region 40 during no-load or idle operation by interrupting,. or restricting (“starving”), the amount of air that is supplied to the cathode 18. This has the effect of relatively moving the Xₒ plane away from the membrane 14 to remain in the cathode 18. To accomplish this form of control, the air from air supply blower 36 is connected to a two-way diverter valve 60, one output of which is connected to cathode 38 via line 38 and gas diffusion layer 34, and the other output may be exhausted to the atmosphere or some temporary storage medium. The diverter valve 60 is controllable by a control line 62 from controller 50 to provide none, some, or all of the air from air supply blower 36 to the cathode 18. Thus, by interrupting some or all of the normal air supply, it is also possible to control the positioning of the Xₒ plane.

In accordance with an aspect of the invention, it may be desirable to accomplish the desired maintenance of the Xₒ plane in the desired Xₒ operating region 40 by a combination of adjusting both the electrical load across lines 22 and 24 and the quantity of air to cathode 18. This reduces the likelihood that either control scheme alone is operated at an extreme or limit, and thus may assure a greater balance and/or efficiency in accomplishing the desired result.

Although the invention has been described and illustrated with respect to the exemplary embodiments hereof, it should be understood by those skilled in the art that the foregoing and various other changes, omissions and additions may be made without departing from the spirit and scope of the invention.

What is claimed is:

1. A fuel cell power plant (10), comprising:
a fuel cell stack (12) including a plurality of membrane electrode assemblies (20), each having a cathode (18) with a catalyst and a reactant air flow field and an anode (16) with a reactant fuel flow field on respective opposite sides of a proton exchange membrane (14), the cathode catalyst having an interface with the membrane (14);
an air supply (36) connected to the air flow fields for providing reactant air to the cathodes; and
a primary electrical load (28) electrically powered by said fuel cell stack; characterized by
a plane of potential change (Xₒ) normally occurring outside the proton exchange membrane at or near the cathode catalyst/membrane interface during operation of the fuel cell stack for electrical load cycling of the primary electrical load, but inside the proton exchange membrane during periods of relatively idle operation;
at least one of: an interrupter (60) operatively connected with the air supply and the cathode air flow fields for selectively interrupting the supply of air to the flow fields and a secondary electrical load (52) for selective connection with the fuel cell stack during periods of relatively idle operation; and
a controller (50) responsive to electrical demand of the primary electrical load to control at least one of the air supply interrupter to interrupt some of the supply of air to the cathode air fields and the secondary electrical load for connection to the fuel cell stack during periods of relatively idle operation, thereby to maintain the plane of potential change (Xₒ) outside the proton exchange membrane also during periods of relatively idle operation.

2. The fuel cell power plant (10) of claim 1 including both said interrupter (60) operatively connected with the air supply and the cathode air flow fields for selectively interrupting the supply of air to the flow fields and said secondary electrical load (52) for selective connection with the fuel cell stack during periods of relatively idle operation, and wherein said controller (50) controls both said air supply interrupter and said secondary electrical load to maintain the plane of potential change (Xₒ) outside the proton exchange membrane also during operation.

3. The fuel cell power plant (10) of claim 2 wherein said interrupter (60) comprises a multi-way diverter valve.

4. The fuel cell power plant (10) of claim 2 wherein said secondary electrical load (52) is selected from the group consisting of a resistance device and an electrical storage device.

5. The fuel cell power plant (10) of claim 2 wherein said secondary electrical load (52) comprises a variable resistor and said interrupter (60) comprises a multi-way diverter valve variable to deliver all, some, or none of the air from air supply (36), and the controller (50) is operative to control both said secondary electrical load and said multi-way diverter valve.

6. A method of mitigating decay of membrane electrode assemblies (20) in a fuel cell stack (12) having a plurality of membrane electrode assemblies (20), each having a cathode (18) with a catalyst and a reactant air flow field and an anode (16) with a reactant fuel flow field on respective opposite sides of a proton exchange membrane (14), the cathode catalyst having an interface with the membrane (14), an air supply (36) connected to the air flow fields for providing reactant air to the cathodes, and a primary electrical load (28) electrically powered by said fuel cell stack, a plane of potential change (Xₒ) normally occurring outside the proton exchange membrane at or near the cathode catalyst/membrane interface during operation of the fuel cell stack for electrical load cycling of the primary electrical load, but inside the proton exchange membrane during periods of relatively idle operation, comprising the steps of:
determining (22, 24, 54, 50) the electrical demand of the primary electrical load on the fuel cell stack relative to a threshold indicative either of load cycling or of relatively idle operation; and
controlling (50, 56, 58, 62) at least one of a secondary electrical load (52) connectable to the fuel cell stack and the air supply in response to an indication of relatively idle operation for maintaining the plane of potential change (Xₒ) outside the proton exchange membrane also during periods of relatively idle operation.

7. The method of claim 6 wherein the step of controlling (50, 56, 58, 60, 62) at least one of a secondary electrical load (52) connectable (26, 24″) to the fuel Cell stack and the air supply (36) comprises connecting (50, 26, 24″, 56) the secondary electrical load (52) to relatively increase the electrical demand on the fuel cell stack in response to an indication of relatively idle operation.

8. The method of claim 6 wherein the step of controlling (50, 56, 58, 60, 62) at least one of a secondary electrical load (52) connectable (26, 24″) to the fuel cell stack and the air supply (36) comprises controlling (50, 62, 60) the flow of air provided by the air supply to relatively restrict the air supplied to the fuel cell stack in response to an indication of relatively idle operation.

9. The method of claim 8 wherein the step of controlling (50, 56, 58, 60, 62) at least one of a secondary electrical load (52) connectable (26, 24″) to the fuel cell stack and the air supply (36) comprises also connecting (50, 26, 24″, 56) the secondary electrical load (52) to, in combination, relatively increase the electrical demand on the fuel cell stack.

10. The method of claim 6 wherein the step of determining (22, 24, 54, 50) the electrical demand of the primary electrical load on the fuel cell stack relative to a threshold indicative either of load cycling or of relatively idle operation comprises monitoring the voltage of the fuel cell stack and wherein the threshold indicative either of load cycling or of relatively idle operation is about 0.85 volt.
